(19) United States
(12) Patent Application Publication
(10) Pub. No.: US 2008/0260937 A1
(43) Pub. Date: Oct. 23, 2008

(54) Luminescent Screen

(75) Inventor: Xinhe Tang, Wien (AT)

Correspondence Address: HENRY M FEIEREISEN, LLC;HENRY M FEIEREISEN, 708 THIRD AVENUE, SUITE 1501, NEW YORK, NY, 10017, US

(73) Assignee: ELECTROVAC AG, Klosterneuburg (AT)

(21) Appl. No.: 12/094,220

(22) PCT Filed: Nov. 17, 2006
(86) PCT No.: PCT/AT2006/000472

§ 371 Date: May 19, 2008

(30) Foreign Application Priority Data
Nov. 18, 2005 (AT) A 1879/2005

(51) Int. Cl. B05D 5/06

(52) U.S. Cl. 427/64

(57) ABSTRACT

The invention relates to a method for producing a field emission layer (3), preferably for luminescent screen applications, according to which in order to improve the serviceable life and long-time stability, a mixture consisting of a polymer (11) and carbon nanofibers (4), which are hardened in a low-oxygen, in particular, oxygen-free atmosphere at temperatures greater than 2000° C., particularly greater than 2500° C., preferably, approximately 3000° C., are applied to a cathode electrode (8) assigned to a cathode (1), and the cathode electrode (8), together with the carbon nanofibers (4)/polymer (11) mixture is heated to a temperature ranging from 300° C. to 500° C., preferably from 380° C. to 480° C., in particular, from 420° C. to 450° C. in an atmosphere at least containing oxygen, e.g. air, a consequence of the oxygen results in a pyrolysis and/or to a hardening of the polymeric base (7), and at least a portion of the carbon nanofibers (4) is exposed over at least a portion of the spatial extension of the carbon nanofibers (4), particularly at least over a portion of the length of the carbon nanofibers (4), in particular, at least over half the length.

The invention relates to a method for producing a field emission layer, preferably for luminescent screen applications.

Methods are known for forming a field emission layer comprising carbon nanofibers for luminescent screens, visual display screens or displays in which a paste which comprises single-wall carbon nanotubes is applied to a cathode. At least individual single-wall carbon nanotubes are withdrawn from the carrier material by means of different methods such as an adhesive tape which is applied to the carrier substrate and is withdrawn from the same. These luminescent screens formed according to the known methods come with the disadvantage however that the employed carrier materials enter into a merely insufficient connection with the cathode. This leads to detachments of the carrier material and thus to a sectional failure of the luminescent screen. In addition to this phenomenon which reduces the service life, there is a strong incineration of the single-wall carbon nanotubes through high heating caused during field emission in the luminescent screens produced according to the known methods, leading to a continual reduction in emission capability and thus luminescent power. As a result, such a known luminescent screen will continually become worse until total failure is reached.

It is therefore the object of the present invention to provide a method for producing a field emission layer, preferably for luminescent screen applications of the kind mentioned above, with which the mentioned disadvantages can be avoided and by which luminescent screens with improved service life and long-term stability can be created.

This is achieved in accordance with the invention in such a way that a mixture consisting of a polymer and carbon nanofibers is applied to a cathode electrode assigned to a cathode, with the carbon nanofibers being hardened in a low-oxygen, especially oxygen-free, atmosphere at temperatures greater than 2,000° C., especially more than 2,500° C., preferably approximately 3,000° C., and that the cathode electrode with the carbon nanofibers/polymer mixture is heated to a temperature ranging between 300° C. and 500° C., preferably between 380° C. and 480° C., especially between 420° C. and 450° C., in an atmosphere at least containing oxygen such as air, with a pyrolysis and/or a hardening of the polymer base occurring as a result of the oxygen, and at least a portion of the carbon nanofibers is exposed over at least a portion of the spatial extension of the carbon nanofibers, especially at least over a portion of the length of the carbon nanofibers, especially over half the length.

As a result of hardening at high temperatures, the carbon nanofibers are essentially resistant against oxidation, so that during pyrolysis under atmosphere comprising oxygen merely the polymer is pyrolyzed or hardened without leading to any substantial combustion of the carbon nanofibers. In addition, the originating heat can be removed by the carbon nanofibers because they have a favorable thermal conductivity. As a result of the larger diameter of the carbon nanofibers and/or the hardening, they also retain their emission capability over a long period of time in the case of combustion, which in the case of conventional single-wall carbon nanotubes would already have led to complete destruction of the fiber. Notice must be taken again that the degree of combustion in the case of the thicker carbon nanofibers used in accordance with the invention is substantially lower than in the case of single-wall carbon nanotubes and/or in the case of thin multi-layer nanotubes.

As a result of the pyrolysis of the polymer base, a major part of the carbon nanofibers are exposed in sections, with a section of the polymer base which is located between a bottom base area of a carbon nanofiber and an electrode associated with the cathode not being removed by the heat of the pyrolysis but hardening instead, thus leading to a secure and permanent bonding of every single carbon nanofiber with the electrode. By exposing the carbon nanofibers by pyrolysis, more carbon nanofibers are available for the emission.

A favorable, durable and long-term stable bonding of the carbon nanofibers with the cathode is given by holding the carbon nanofibers in a hardened and/or pyrolyzed polymer base. The pyrolysis leads to an exposure of the uppermost layer of carbon nanofibers, through which they are provided with good emission properties. Pyrolysis can be applied without any noteworthy impairment of emission density, e.g. by excessive combustion of carbon nanofibers, by the ability of the carbon nanofibers to dissipate heat.

One variant of the invention can be that carbon nanofibers/polymer mixture comprises thick multi-layer nanotubes and at least one polycondensate, thermoplastic and/or thermosetting plastic. The combustion of the carbon nanofibers can be reduced even further by using carbon nanofibers and/or thick multi-layer nanotubes instead of single-wall carbon nanotubes because the carbon nanofibers and/or thick multi-layer nanotubes are thermally more stable as a result of the multi-layer configuration, through which the emission properties and the service life of a field emission layer thus created can be increased even further. Any combustion which is also present in carbon nanofibers and/or thick multi-layer nanotubes is substantially lower as a result of the favorable heat dissipation than is the case in single-wall carbon nanotubes at the same temperature for example.

It can be provided in a further development of the invention that merely the cathode electrode with the carbon nanofibers/polymer mixture is heated. In this way, only the area is heated in a purposeful way which was exposed by pyrolysis. The purposeful heat effect can support the exposure of the carbon nanofibers and the formation of emission peaks by the carbon nanofibers.

According to a further embodiment of the invention it can be provided that the carbon nanofibers are aligned under the influence of an electrostatic field. It can thus be achieved that the carbon nanofibers will stand substantially perpendicular to the electrode and will thus have the smallest possible distance to the anode, as a result of which the necessary potential difference to the field emission is reduced. A lower potential difference means a lower applied voltage and a lower heating of the carbon nanofibers, through which the combustion of the carbon nanofibers is reduced and the service life is increased.

According to yet another embodiment of the invention it can be provided that the carbon nanofibers/polymer mixture is applied to the cathode electrode by means of screen printing. Predeterminable structures can be applied to an electrode in a simple automated way.

Another possible embodiment can be that the carbon nanofibers/polymer mixture which is applied to the cathode electrode comprises 1 to 30%, especially 5 to 20%, preferably 10 to 15% of carbon nanofibers and 70 to 99%, especially 80 to 95%, preferably 85 to 90% of polymer. This helps achieve a very advantageous ratio between the emission capability of the field emission layer and the bonding to the cathode electrode.

The invention relates further to a luminescent screen and/or visual display screen with at least one cathode and at least one anode, with the cathode comprising a field emission layer which comprises carbon nanofibers at least in sections which are held by a hardened and/or pyrolyzed polymer base, and with the anode comprising at least one luminescent layer, preferably comprising an inorganic luminescent element.

Luminescent screens, visual display screens or displays re known which have a field emission layer with carbon nanofibers. Single-wall carbon nanotubes are especially used in known field emission luminescent screens because they have an especially high emission capability. Therefore, a carrier substrate such as a paste which comprises single-wall carbon nanotubes is applied to a cathode. At least individual single-wall carbon nanotubes are pulled out of the carrier material by means of different methods such as by means of an adhesive tape for example which is applied to the carrier substrate and is pulled off the same. As already explained above and according to the reasons as already described above, such luminescent screens or field emission layers come with the disadvantage that they will age rapidly and have a short service life.

It is therefore the object of the invention to provide a luminescent screen of the kind mentioned above with which the mentioned disadvantages can be avoided and which has an improved service life and long-term stability.

This is achieved in accordance with the invention in such a way that the carbon nanofibers have a diameter of larger than 70 nm, especially larger than 100 nm.

By using carbon nanofibers which are arranged especially as carbon nanofibers and/or thick multi-layer nanotubes with a diameter of at least 70 nm instead of single-wall carbon nanotubes, it is possible to substantially prevent the combustion of carbon nanofibers because the carbon nanofibers with a diameter of at least 70 nm can better withstand the temperatures occurring during field emission. The arising heat can be removed by the thick carbon nanofibers. Any combustion which also occurs in such thick carbon nanofibers is substantially lower than is the case with single-wall carbon nanotubes at the same temperatures due to the favorable heat dissipation. As a result of the larger diameter of the carbon nanofibers, they still maintain their emission capability over a long period of time in the case of a combustion which in the case of single-wall carbon nanotubes would have already led to a complete destruction of the fibers. Notice shall be taken again that the degree of combustion in the carbon nanofibers in accordance with the invention is substantially lower than in single-wall carbon nanotubes.

By holding the carbon nanofibers in a hardened and/or pyrolyzed polymer base, a favorable, durable and long-term stable bonding of the carbon nanofibers to the cathode is given. The pyrolysis leads to an exposure of the uppermost layer of the carbon nanofibers, as a result of which the same are provided with favorable emission properties. By using thick carbon nanofibers and their capability to dissipate heat it is possible to apply pyrolysis without any noteworthy impairment of the emission density such as one caused by excessive combustion of carbon nanofibers.

In this connection it can be provided that the carbon nanofibers have a diameter of less than 300 nm, especially less than 200 nm. This helps achieve an especially favorable balance between long-term stability and the heat dissipation capability and emission capability.

It can be provided in a further development of the invention that the carbon nanofibers are hardened at temperatures of more than 2,000° C., especially more than 2,500° C., preferably approximately 3,000° C., preferably in low-oxygen, especially oxygen-free, atmosphere. By hardening at high temperatures in a low-oxygen atmosphere, the carbon nanofibers are substantially resistant against oxidation, so that in the case of pyrolysis under atmosphere which contains oxygen merely the polymer is pyrolyzed or hardened without leading to any noteworthy combustion of the carbon nanofibers.

In this context it can be provided in a further development of the invention that the polymer base comprises thermosetting plastic materials, preferably epoxy resin and/or polyester, especially unsaturated polyester resins. This enables especially favorable pyrolysis and an especially favorable bonding to the cathode is achieved by the layer which hardens under heat.

It can be provided in a further embodiment of the invention that the polymer base comprises at least one solvent. The properties of the polymer base can thus be influenced in a positive way.

According to a further embodiment of the invention it can be provided that the carbon nanofibers and/or the polymer base are arranged on a metal electrode which is associated with the cathode and especially comprises silver. This enables an arrangement of a cathode which offers favorable conductivity and a simple configuration.

According to yet another embodiment of the invention it can be provided that at least one translucent plate, especially a first glass plate or plastic plate, is arranged on a side of the luminescent layer averted from the cathode. This enables the light output from the luminescent layer out of the luminescent screen and provides favorable and permanent protection of the luminescent screen.

One variant of the invention can be that the cathode is sealed off by a second glass plate on a side averted from the anode. This enables favorable and effective insulation of further modules, as a result of which a low parasitic capacitance is built up by the glass plate and a background lighting and/or see-through display is enabled.

According to a further embodiment of the invention it can be provided that breakthroughs of the cathode and/or the glass plate and especially cracks, holes, pores and/or defects penetrating the same are sealed in a vacuum-tight manner by the polymer base. The pin lead-through of the cathode and/or the glass plate can be sealed in a vacuum-tight manner in a single work step with merely one polymer.

The invention is now explained in closer detail by reference to the enclosed drawings which merely show an especially preferred embodiment, wherein:

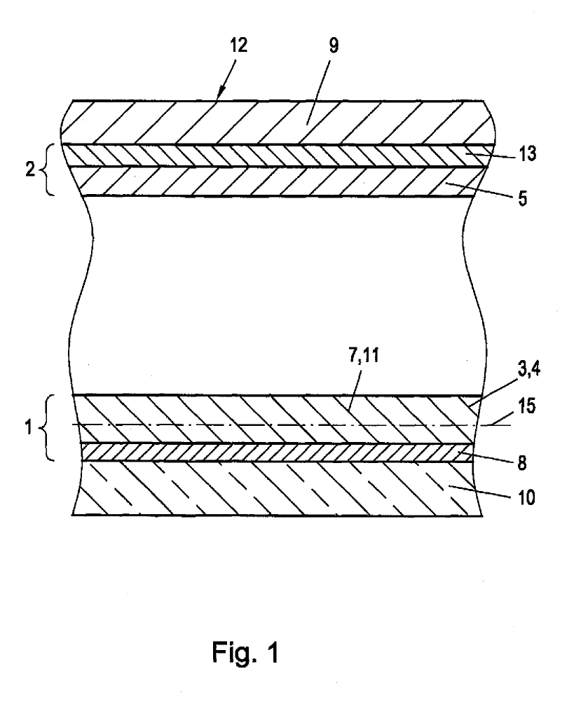

FIG. 1 shows a sectional view of a luminescent screen in accordance with the invention;

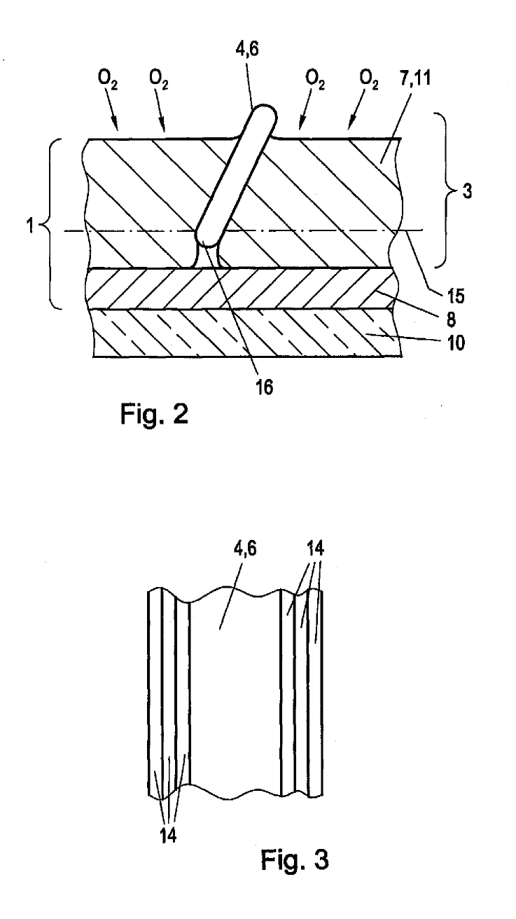

FIG. 2 shows a detailed view of the cathode of a luminescent screen in accordance with the invention;

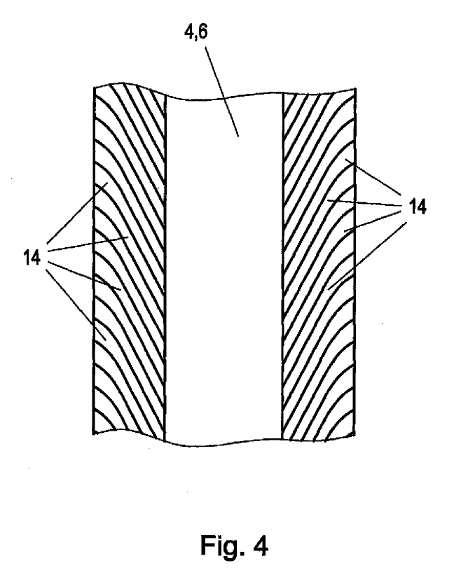

FIG. 3 shows a detailed view of a first embodiment of a thick multi-layer nanotube, and

FIG. 4 shows a detailed view of a second embodiment of a thick multi-layer nanotube.

FIGS. 1 to 3 shows an especially preferred embodiment and details of an especially preferred embodiment of a luminescent screen and/or visual display screen, comprising at least one cathode 1 and at least one anode 2, with the cathode 1 comprising a field emission layer 3 which comprises carbon nanofibers 4 at least in sections which are held by a hardened or pyrolyzed polymer base 7, and with the anode 2 comprising at least one luminescent layer 5, preferably comprising inorganic luminescent elements, especially doped rare earths, with the carbon nanofibers 4 which are especially arranged as carbon nanofibers and/or thick multi-wall nanotubes 6 having a diameter of larger than 70 nm, especially larger 100 nm.

Only the term luminescent screen will be used below for luminescent screen and/or visual display screen. The luminescent screen in accordance with the invention concerns a luminescent screen for so-called flat displays such as flat screens for notebook computers, digital cameras, mobile phones, flat screen TVs, displays in aircraft cockpits or any other application of a flat screen or luminescent screen.

Luminescent screens in accordance with the invention comprise at least one cathode 1 and an anode 2 which are arranged opposite of each other at least in sections within the luminescent screen. It can preferably be provided that a cathode 1 is arranged opposite of an anode 2 each or vice-versa. Any kind, shape and structure of an anode 2 and/or cathode 1 can be provided. A plurality of cathodes 1 and/or anodes 2 can especially be provided. It can be provided to arrange anodes 2 and/or cathodes 1 in such a way that a luminescent screen in accordance with the invention is capable of displaying a predetermined image, e.g. by purposeful triggering of individual pixels, but it can also be provided that the anode 2 and/or cathode 1 have the shape and arrangement of symbols to be displayed, e.g. when being used as a warning and/or checking display, as seven-segment display or as an optical signaling device with a merely limited set of fonts. It can be provided to arrange a cathode 1 arranged merely in sections opposite of an anode 2 arranged over the entire surface area and vice-versa.

In a preferred embodiment, the luminescent screen is delimited by at least one at least translucent plate 9, especially a first glass plate or a plastic plate such as an acrylic plate or a polymethyl methacrylate plate according to an outside 12 averted from the anode 2.

The anode 2 is arranged on a side of the translucent plate 9 averted from the outside 12. The anode 2 comprises at least one anode electrode 13 which can be arranged in a simple embodiment from a plurality of thin aluminum threads which cover the luminescent screen and which can comprise indium tin oxide in an especially preferred embodiment. In the simplest embodiment of the invention, at least one luminescent layer 5 is arranged on a side of the anode 2 averted from the cathode 1, which layer preferably comprises inorganic luminescent elements such as doped rare earths and/or phosphorus. It is also possible to provide several luminescent layers 5, preferably three, with each being provided for a different color.

A preferably evacuated space which is delimited by cathode 1 is provided adjacent to the side of the luminescent layer 5 facing the cathode 1.

Cathode 1 comprises carbon nanofibers 4 at least in sections, which fibers are held by a hardened and/or pyrolyzed polymer base 7. The polymer base 7 is arranged on a metal electrode 8 or is connected with such a one, with the metal electrode 8 preferably comprising copper, aluminum and/or silver. The cathode electrode 8 can preferably be arranged in the form of thin wires. A matrix-like arrangement may especially be provided with which individual sections or points of the cathode 1 can be triggered in a purposeful way. In an especially preferred embodiment, the cathode 1 is sealed or delimited by a second glass plate 10 on a side averted from the anode 2. As an alternative it is also possible to provide a mirror or a plate comprising plastic and/or metal. It can be provided in especially preferred embodiments that the carbon nanofibers 4/polymer mixture is applied by means of screen printing to the cathode electrode 8, which thus enables predeterminable structures to be applied to a cathode electrode 8 in a simple automated way.

It is provided in luminescent screens in accordance with the invention that only the carbon nanofibers 4 are used for the intended field emission. As a result of the small dimensions of such carbon nanofibers 4, very high field strengths will occur locally at their ends protruding freely into space when applying a potential difference to an anode 2 arranged opposite thereto.

FIG. 1 shows a sectional view of a preferred embodiment of a luminescent screen in accordance with the invention. The spatial separation between anode 2 and cathode 1 can be clearly recognized as well as the principal arrangement of the anode 2 with translucent plate 9, anode electrode 13 and luminescent layer 5 as well as the cathode 1 with the second glass plate 10, cathode electrode 8 and the polymer base 7 comprising carbon nanofibers 4.

It is provided in accordance with the invention that the carbon nanofibers 4 have a diameter of at least 70 nm, preferably 100 nm, with the carbon nanofibers 4 especially concerning so-called carbon nanofibers and/or thick multi-layer nanotubes 6. According to the usual technical designations, carbon nanofibers and/or thick multi-layer nanotubes 6 concern carbon nanofibers 4 which in contrast to single-wall carbon nanotubes have a plurality of covers or layers 14.

The term multi-layer nanotubes 6 shall merely be used below for carbon nanofibers and/or thick multi-layer nanotubes 6.

As a result of the plurality of covers and/or layers, such multi-layer nanotubes 6 have a substantially larger diameter as compared with single-wall carbon nanotubes. FIG. 3 shows a part of a first embodiment of a multi-layer nanotube 6 which comprises three layers 14 adjacent to one another. FIG. 4 shows a second embodiment of a multi-layer nanotube 6 which comprises layers 14 which lead out in a radial manner and are arranged tightly adjacent to one another, with the multi-layer nanotube 6 thus formed being substantially cylindrical. It is possible that more or less layers 14 are present, as is shown, and combinations of the first and second embodiment. It is preferably provided that the carbon nanofibers 4 have a diameter which is larger than 70 nm, especially larger than 100 nm and preferably smaller than 300 nm, especially smaller than 200 nm.

By using multi-layer nanotubes 6 instead of single-wall carbon nanotubes, the combustion of carbon nanofibers 4 can be prevented substantially because the multi-layer nanotubes 6 are able to substantially withstand the temperatures occurring during field emission. The occurring heat can be dissipated through the thick multi-layer nanotubes 6. An additional factor is that the carbon atoms which are arranged in the multi-layer nanotubes 6 have a more solid bonding than the carbon atoms in single-wall carbon nanotubes, which is why the same are more stable at high temperatures. Any combustion which is also present in multi-layer nanotubes 6 is substantially lower as a result of the favorable heat dissipation than is the case with single-wall carbon nanotubes at the same temperatures. As a result of the larger diameter of the multi-layer nanotubes 6, they will still continue to be capable of emission after combustion to an extent which in the case of single-wall carbon nanotubes would already have led to a complete destruction of the fiber. Notice must be taken again that the degree of combustion in multi-layer nanotubes 6 is substantially lower than in single-wall carbon nanotubes.

It is provided especially preferably that the carbon nanofibers 4 are hardened at temperatures of more than 2,000° C., especially more than 2,500° C., preferably approximately 3,000° C. in a preferably low-oxygen, especially oxygen-free, atmosphere, e.g. a noble gas atmosphere, through which the carbon nanofibers are substantially resistant against oxidation, so that during pyrolysis under an atmosphere comprising oxygen merely the polymer is pyrolyzed or hardened without giving rise to any noteworthy combustion of the carbon nanofibers 4. The percentage of the carbon nanofibers 4 hardened or stabilized under such high temperatures in the substrate such as a finished field emission display or a carbon nanofibers 4/polymer 11 mixture can be determined through measurement by means of so-called TGA, thermogravimetric analysis.

Carbon nanofibers 4 are embedded in a polymer base 7 or are held by a polymer base 7.

According to a method in accordance with the invention for producing a field emission layer 3, preferably for luminescent screen applications, it is provided that a mixture consisting of a polymer 11 and carbon nanofibers 4 is applied to a cathode electrode 8 assigned to a cathode 1, with the carbon nanofibers 4 being hardened in a low-oxygen, especially oxygen-free, atmosphere at temperatures greater than 2,000° C., especially more than 2,5000° C., preferably approximately 3,000° C., and that the cathode electrode 8 with the carbon nanofibers 4/polymer 11 mixture is heated to a temperature ranging between 300° C. and 500° C., preferably between 380° C. and 480° C., especially between 420° C. and 450° C., in an atmosphere at least containing oxygen such as air, with a pyrolysis and/or a hardening of the polymer base 7 occurring as a result of the oxygen, and at least a portion of the carbon nanofibers 4 is exposed over at least a portion of the spatial extension of the carbon nanofibers 4, especially at least over a portion of the length of the carbon nanofibers 4, especially over at least half the length. Prior to mixing with the polymer 11, the carbon nanofibers 4 are hardened in a low-oxygen, especially oxygen-free, atmosphere at temperatures of more than 2,000° C., especially more than 2,500° C., preferably approximately 3,000° C. After the hardening, the carbon nanofibers 4 are mixed with the polymer 11 and a paste is thus formed which can be applied in a simple manner in one pass to the cathode electrode 8.

The polymer base 7 can concern any kind of polymer compound with which such pyrolysis is possible. It can preferably be provided that the polymer base 7 comprises thermosetting plastics, preferably epoxy resin and/or polyester, and especially unsaturated polyester resins. It can especially be provided that the polymer base 7 comprises boron and/or silver, with the silver making the polymer base 7 more conductive and thus improving the electric contact with the carbon nanofibers 4, and with the boron reducing the combustion of the carbon nanofibers 4 during pyrolysis, as a result of which a larger number of carbon nanofibers 4 are available for emission after pyrolysis.

For simpler processing and/or for adjustment of the properties of the polymer base it can be provided that the polymer base comprises at least one solvent.

In an especially preferred embodiment of a method in accordance with the invention it can be provided that merely the cathode electrode 8 with the carbon nanofibers 4/polymer 11 mixture is heated, whereupon merely the area is heated in a purposeful way which is to be exposed by pyrolysis. The purposeful heat effect can support the exposure of the carbon nanofibers and the formation of emission peaks by the carbon nanofibers.

Furthermore, a purposeful heat dissipation from the cathode can be provided in order to prevent direct heating of the carbon nanofibers, such that the areas of the carbon nanofibers are cooled which are not subjected directly to heating. Since the carbon nanofibers conduct heat in an exceptionally good way, this will lead to an effective cooling of the carbon nanofibers. The service life of the carbon nanofibers during pyrolysis and concomitant heating is thus extended by cooling the bottom side of the cathode or the carrier of the cathode because the heat guided or dissipated by the carbon nanofibers can be removed in a purposeful way from the bottom side of the glass plate. As a result, fewer carbon nanofibers are destroyed during pyrolysis and are available for field emission.

In order to achieve a balanced and advantageous ratio between emission capability of the field emission layer and the bonding to the cathode electrode 8 it can be provided that the carbon nanofibers 4/polymer 11 mixture which is applied to the cathode electrode 8 comprises 1 to 30%, especially 5 to 20%, preferably 10 to 15% of carbon nanofibers 4 and 70 to 99%, especially 80 to 95%, preferably 85 to 90% polymer 11.

The major part of the polymer base 7 is removed during pyrolysis. FIG. 1 shows the polymer base 1 in its full thickness prior to pyrolysis. A dot-dash line 15 shows a possible surface progression of the polymer base 7 after performed pyrolysis. Notice shall be taken at this point that the dimensions of the schematic illustration according to FIG. 1 need not concern scaled dimensions or proportions.

By removing the polymer base 7, the carbon nanofibers 4 of at least an uppermost layer are exposed, thus leading to favorable emission properties.

The heating of the cathode 1 and the associated polymer base 7 not only leads to a pyrolysis of the polymer base 7, but also to a hardening of the same in sections. Especially areas between the individual carbon nanofibers 4 and the metal electrode 8 are hardened by the heat effect without being removed by pyrolysis. This leads to a fixed and permanent bonding of every single carbon nanofiber 4. A favorable, durable and long-term stable bonding of the carbon nanofibers 4 to the cathode 1 is achieved by holding the multi-layer nanotubes 6 in a hardened and/or pyrolyzed polymer base 7. By using multi-layer nanotubes 6 and their ability to dissipate heat, pyrolysis can be applied without any noteworthy impairment of the emission density, e.g. by excessive combustion of carbon nanofibers 4.

FIG. 2 shows a detail of a schematic representation of a cathode electrode 8 with a polymer base 7 arranged thereon, comprising a single carbon nanofiber 4. The hatched area of polymer base 7 illustrates its thickness prior to pyrolysis. The dot-dash line 15 shows the surface progression of the polymer base 7 after performed pyrolysis. The arrows with lettering O2 refer to the influence of oxygen during pyrolysis. The base area 16 beneath the carbon nanofiber 4 hardens under the influence of pyrolysis heat and under lack of oxygen, thus leading to the already mentioned favorable and permanent bonding of the carbon nanofibers 4 to the cathode electrode 8.

In order to reduce the operating voltage of the luminescent screen or to further increase service life it can be provided that the carbon nanofibers 4 are aligned under the influence of an electrostatic field. This helps ensure that the carbon nanofibers 4 will stand substantially perpendicular to the cathode electrode 8 and will thus have the lowest possible distance to anode 2, thus reducing the necessary potential difference to the field emission. A lower potential difference means a lower applied voltage and a lower heating of the carbon nanofibers 4, thus reducing the combustion of the carbon nanofibers 4 and increasing service life.

For further improving the production it can be provided that breakthroughs of cathode 1 and/or the glass plate 10, especially cracks, holes, pores and/or defects penetrating the same, are sealed in a vacuum-tight way by the polymer base, through which defects of the cathode and/or the glass plate can be sealed in a vacuum-tight way in a single pass with merely one polymer, so that the luminescent screen has a higher service life at lower production costs than known solutions.

Further embodiments in accordance with the invention merely have a part of the described features. Any combination of features can be provided.

1.-15. (canceled)

16. A method for producing a field emission layer, comprising the steps of:
hardening carbon nanofibers at a temperature of more than 2,000° C. in the presence of a first atmosphere which is substantially free of oxygen;
applying a mixture of a polymer and the carbon nanofibers to a cathode electrode associated with a cathode;
heating the cathode electrode with the mixture of carbon-nanofibers and polymer to a temperature between 300° C. and 500° C. in a second atmosphere containing at least oxygen, causing a pyrolysis and/or a hardening of a polymer base as a result of the presence of oxygen;
exposing at least a portion of the carbon nanofibers over at least a portion of a spatial extension of the carbon nanofibers; and
holding the carbon nanofibers by the hardened and/or pyrolyzed polymer base.

17. The method of claim 16, wherein the field emission layer is used for a luminescent screen application

18. The method of claim 16, wherein the cathode electrode is heated to a temperature between 380° C. and 480° C.

19. The method of claim 16, wherein the cathode electrode is heated to a temperature between 420° C. and 450° C.

20. The method of claim 16, wherein the portion of the carbon nanofibers is exposed over at least a portion of a length of the carbon nanofibers.

21. The method of claim 16, wherein the portion of the carbon nanofibers is exposed over at least half a length of the carbon nanofibers.

22. The method of claim 16, wherein the second atmosphere contains air.

23. The method of claim 16, wherein the carbon nanofibers are hardened at a temperature of more than 2500° C.

24. The method of claim 16, wherein the carbon nanofibers are hardened at a temperature of approximately 3000° C.

25. The method of claim 16, wherein the first atmosphere is oxygen-free.

26. The method of claim 16, wherein the first atmosphere is a noble gas atmosphere.

27. The method of claim 16, wherein the mixture comprises thick multi-layer nanotubes, and at least one polycondensate, thermoplastic or thermosetting plastic.

28. The method of claim 16, wherein merely the cathode electrode with the mixture of carbon nanofibers and polymer is heated.

29. The method of claim 16, further comprising the step of aligning the carbon nanofibers under the influence of an electrostatic field.

30. The method of claim 16, wherein the mixture of carbon nanofibers and polymer is applied to the cathode electrode by means of screen printing.

31. The method of claim 16, wherein the mixture of carbon nanofibers and polymer contains 1 to 30% of carbon nanofibers and 70 to 99% of polymer.

32. The method of claim 31, wherein the mixture contains 5 to 20% of carbon nanofibers.

33. The method of claim 31, wherein the mixture contains 10 to 15% of carbon nanofibers.

34. The method of claim 31, wherein the mixture contains 80 to 95% of polymer.

35. The method of claim 31, wherein the mixture contains 85 to 90% of polymer.
